(19) United States
(12) Patent Application Publication
(10) Pub. No.: US 2008/0288274 A1
(43) Pub. Date: Nov. 20, 2008

(54) SYSTEM AND METHOD FOR CROSS-BORDER INTERLINKING OF NATIONAL POSTS

(75) Inventors: Ulisse Del Gallo Roccagiovine, Rome (IT); Brian Moran, Cleveland, OH (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 12/110,861

(22) Filed: Apr. 28, 2008

Related U.S. Application Data
(60) Provisional application No. 60/924,049, filed on Apr. 27, 2007.

(51) Int. Cl. G06Q 30/00

(52) U.S. Cl. 705/1

(57) ABSTRACT

The present invention interconnects national postal systems to provide for international shipping capabilities through a global post. More particularly, the present invention provides end-to-end visibility and monitoring of shipped parcels and documents through coordinated and/or standardized tracking. Also, the invention provides for allocation between national posts of monies received for a shipment serviced by both initiating and destination posts. Certain embodiments of the invention provide digital archiving of shipped documents. Particular embodiments of the invention allow national posts to act as third-party payors through the global post for purchases from foreign manufacturers.

### CROSS-REFERENCES TO RELATED APPLICATIONS

This application claims the benefit of priority of prior co-owned and co-pending U.S. provisional patent application Ser. No. 60/924,049, filed on Apr. 27, 2007.

### BACKGROUND

1. Field of the Invention

The present invention relates generally to the field of interfacing of disparate systems for shipping and tracking parcels. More particularly, the present invention relates to the interfacing national postal systems to form a network with coordinated shipping and tracking capabilities, including advanced payment and customs services.

2. Background Art

The market for in-border parcel shipping has matured, but the emerging cross-border market continues to grow to meet the demands of international business and the global community. A national post is a postal system operating primarily within a particular nation, such as the United States Postal Service or Poste Italiane. Currently, national posts around the world do not provide global visibility on end-to-end shipping services. As a result, businesses and individuals must rely heavily on private shippers in order to ship parcels internationally.

For example, although international shipping occurring on e-commerce websites such as eBay® allows the use of national post offices, there are limited and inconsistent international tracking and payment capabilities with the services provided by the national posts. This is because most posts do not provide a complete “postal option” from one country to another; they only provide postal options within their own borders. Thus, purchasers are forced to rely on private shipping companies, which can be quite expensive internationally. In addition, it may be difficult for purchasers to pay in the currency of the seller.

Package tracking is also a challenge for posts attempting to ship internationally. Today, posts have limited ability to track a standard package between countries because each domestic post may use different tracking methods and/or codes.

Purchasers also turn to private shipping companies due to the lack of customs support provided by national posts. Rather than managing and/or expediting parcels through customs, if domestic posts provide any customs services, they generally only inform the shipper of delays and instruct them to contact customs. Many national posts merely drop parcels at customs and wait for their clearance.

What is needed is a solution to allow a complete order-to-cash tool with heavy integration to the postal world that would allow both the buyer and seller to monitor their order along with shipping status and other tracking information. This solution would also manage payment allocation, affect customs handling, handle returns, provide carrier pickup, and conduct address and other verification.

### SUMMARY OF THE INVENTION

The invention provides the ability to interlink the national posts around the globe, which, when interlinked, combine global reach with local presence. This global post standardizes and streamlines the exchange of information between international buyers and sellers. Additionally, a global post takes advantage of the cost savings offered by national posts in comparison to private courier services. Domestic national posts combine widespread reach, visiting every home and business in areas with universal service, with the reliability and consistency of service at approximately the same time each business day. National posts have pervasive retail networks and presence with large, highly automated processing and distribution networks. National posts also generally provide closer drop off and pick up locations than private couriers due to the great diffusion of local post offices. A global post according to this invention allows international shippers and customers to take advantage of these benefits that are currently primarily reserved for domestic shipments.

The invention further provides support for ensuring compliance with international postal treaties as well as national legal obligations. For example, one embodiment of the invention prints all necessary shipping labels for the shipping country and the receiving country, such that each printed label is in compliance with the appropriate country.

The invention also provides international coordination capabilities. In particular, the invention provides international post financial settlement (payment) interface and processes, international tracking capabilities, and customs clearing and expediting systems/processes.

The invention further provides interface with e-commerce web-sites, so that a seller could offer to ship their product via the national post (or combination of national posts) from any address in the world to any other address in the world with consistent visibility and tracking services from end-to-end.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the figures:

FIG. 1 illustrates an overview of a system for interlinking posts across national borders;

FIG. 2 illustrates a system and method of shipping a parcel using the invention; and

FIG. 3 illustrates a method of purchasing goods online to be shipped internationally.

### DETAILED DESCRIPTION OF EMBODIMENTS OF THE INVENTION

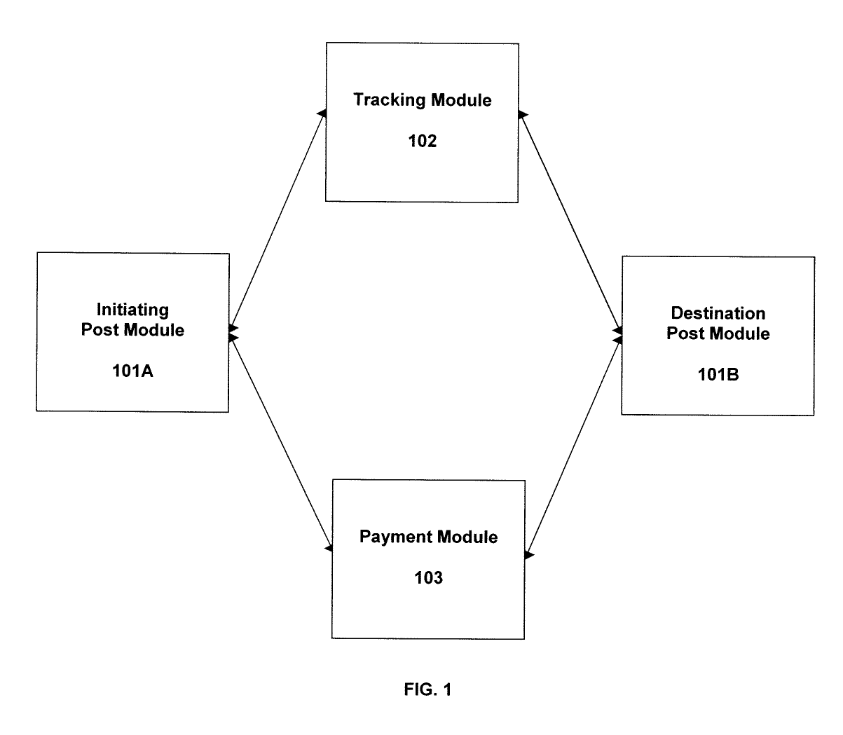

Illustrated in FIG. 1 is an overview of the invention, including a plurality of post modules 101 (which could be nodes, e.g., websites, of a global computer network), a tracking module 102 (which could be one or more servers on a global computer network), and a payment module 103 (which could also be one or more servers on a global computer network). Each national post may use its own post module 101 internally for shipping parcels, or the national posts may adopt uniform systems, such as those that utilize standard protocols. The tracking module 102 interconnects the tracking systems of national posts over a global computer network such as the internet. The payment module 103 provides for transferring payments between posts—payment for shipping a parcel is typically received at an initiating post, meaning that a destination post must receive payment for its part of the shipment from the initiating post. In certain embodiments, the payment module 103 also apportions/allocates the payment between the initiating and destination posts.

In operation, merely as an example, a customer ships a parcel through an initiating post. Tracking and payment information such as that for shipping costs regarding the parcel are stored in the initiating post module 101A, such as in a memory device or database. Once the initiating post module 101A has determined the correct foreign post to which to ship the parcel, it transmits instructions for the shipping cost payment to the payment module 103. The payment module 103 then transmits or otherwise arranges for such payment to the destination post module 101B. The payment module 103 handles all necessary currency conversions and discounts, as agreed upon by the participating posts. This payment approach takes advantage of the national posts' financial relationship with its citizens. The initiating post acts as a trusted agent of the shipper and reduces the destination post's exposure to fraud.

In another embodiment, the payment module 103 may also allow a national post to act as a third-party payer for the cost of goods in addition to the cost of shipping. For example, a customer may desire to purchase from a foreign seller who does not accept foreign or international credit cards. The customer's domestic post, through a global post, may purchase the merchandise on behalf of the customer and remit payment to the seller for the goods and to the foreign national post for the appropriate portion of the shipping costs.

The tracking module 102 provides end-to-end visibility and monitoring of parcel shipment. While the parcel is being tracked by the initiating post module 101A, i.e., the parcel is still in the originating country, the initiating post module 101A sends tracking information to the tracking module 102, which forwards that information to the destination post module 101B. In this way, a foreign post can provide correct tracking information to its customers, e.g., through its website in communication with tracking module 102, even though the parcel is not yet in the control of the foreign post. Once the parcel has reached the foreign post, the destination post module 101B then begins to track it. Updated tracking information is sent to the tracking module 102 by the destination post module 101B, which tracking module then sends that information to the initiating post module 101A. This updated information allows a shipper to track the parcel through the domestic post's services (e.g., a tracking website), even though the parcel is now in the control of the foreign post.

In an alternative embodiment, the tracking module 102 itself may be accessed by customers as a single point of obtaining tracking information. In one embodiment, both the initiating post module 101A and destination post module 101B send tracking information to the tracking module 102, which the shipper and customer can access, e.g., through a website. In another embodiment, the tracking module 102 acts as an access point that directs shippers and customers to the tracking information as presented by the national posts, e.g., through the national post websites.

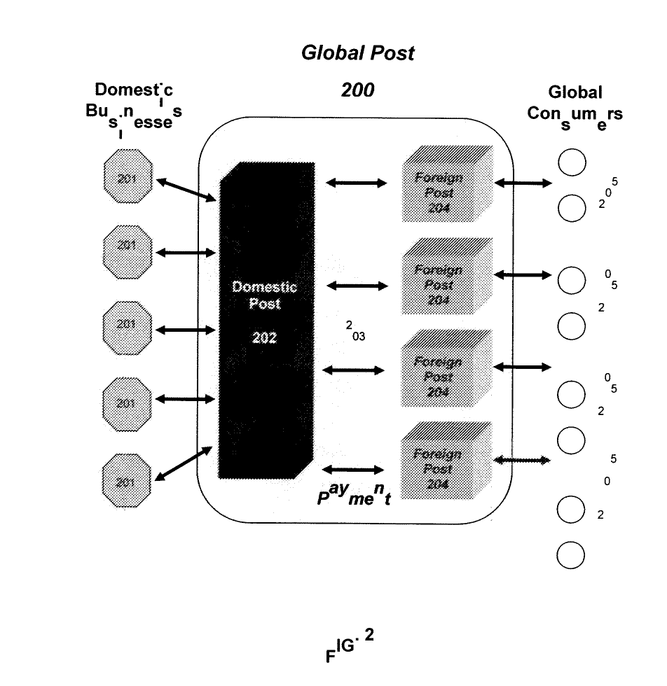

As illustrated in FIG. 2, the invention provides a global post system and method 200, allowing the shipment of goods from domestic business nodes 201 to foreign consumer nodes 205 using only national posts. In operation, a domestic business node 201 ships a parcel through the domestic post module 202 as it would if the end consumer was at a domestic address. In one embodiment, the parcel is shipped to a special drop-off address in the originating country that indicates that the parcel is destined for a foreign country. The drop-off address may be indicated by the shipper or automatedly determined through the domestic post module. The domestic post module 202 may choose to consolidate multiple parcels into one shipment for transport to the foreign post to take advantage of economies of scale. The domestic post module 202 then transports the parcel to the correct foreign post module 204. This transportation may be performed by the domestic post, a foreign post, or a third-party shipper. Once the parcel is received at the foreign post module 204, the foreign post delivers it as if the parcel had been shipped internally to the consumer node 205.

In order to enable this delivery, the parcel is labeled with sufficient information for both the domestic post module 202 and the foreign post module 204 to perform the internal delivery. Further, because different countries have different labeling requirements, the labeling of the parcel should comply with the laws and regulations of both the initiating country and the destination country. Additionally, the invention allows tracking of the parcel throughout the entire shipping procedure transparently, that is, without the user being aware of a difference in tracking between any two countries.

In one embodiment, the shipping information for both countries is generated at the time of shipping and printed onto either two separate labels or one large label with two separate portions. This shipping information also includes tracking information for the entire trip. For example, there might be a single bar code used for all countries in order to unify input of tracking data, which is then sent to the tracking module.

In another embodiment, the national post modules manage and expedite the clearance of the parcel through the relevant customs processes. In this embodiment, beyond passive notification to the shipper of customs delays, the national post actively provides information or payment required by customs in order to expedite the clearance process.

As further illustrated in FIG. 2, the domestic post module 202 receives payment from the shipper. Through a payment module 203, the appropriate portion of that payment is transferred to the foreign post module 204 automatically by the payment module.

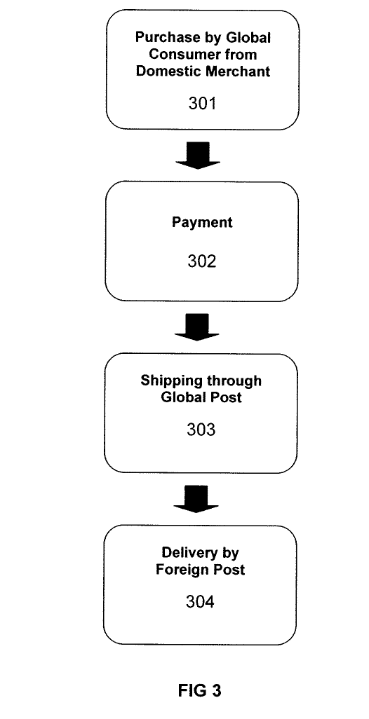

FIG. 3 illustrates a method of purchasing a product that must be shipped internationally. In the purchase step 301, the consumer purchases a product at a website located in a foreign country. The consumer might make payment 302 using a credit card or a third-party payment service, such as PayPal®. In the payment step 302, the consumer pays for shipping. The shipping cost through the global post office will include domestic and international shipping, i.e., the moneys for the foreign post.

In the shipping step 303, the consumer has the package shipped through the global post office and the parcel is delivered at step 304 by the foreign post to the consumer's address. In one embodiment, the merchant need not be aware that the package is being shipped internationally and can ship to a general global post domestic address. In this embodiment, the global post office has information regarding the foreign address. This may be done by providing each foreign consumer a unique global post office address, much like a Post Office Box number, so that the global post office can simply route the parcel based on that unique address. Such an address might be permanent or might be temporary, depending on the needs of the foreign consumer.

While the above descriptions focus on parcels, the present invention can also apply to the transport of documents. In certain embodiments, the global post provides outsourced business processes in addition to traditional post services. In one such embodiment, the global post provides digital archiving capabilities for documents, such as in a database on a server on a global computer network. For example, the initiating national post scans a document being physically sent through the global post and makes the electronic version/digital image accessible to the shipper and customer during and after the shipment process. Thus the shipper and customer can confirm that the document being shipped is the correct/desired document prior to delivery of the physical paper(s).

The various systems and methods described herein may be implemented using software stored in the memory for execution by suitable processors. Alternatively, mobile devices and/or servers may implement such processes and methods in hardware or a combination of software and hardware, including any number of processors independently executing various programs and dedicated hardware, such as application specific integrated circuits (ASICs), field programmable gate arrays (FPGAs), and the like. The invention may also be implemented in a computer-based system including a processor and a computer-readable medium encoding instructions for executing the various global post processes.

Having described preferred embodiments of the invention it will now become apparent to those of ordinary skill in the art that other embodiments incorporating these concepts may be used. Accordingly, it is submitted that the inventions should not be limited to the described embodiments but rather should be limited only by the spirit and scope of the appended claims. Although the invention has been described and illustrated with a certain degree of particularity, it is understood that the present disclosure has been made only by way of example, and that numerous changes in the contribution and arrangement of the steps or orientation of parts can be resorted to by those skilled in the art without departing from the spirit and scope of the invention, as hereinafter will be later claimed.

We claim:

1. A method of providing international shipment through national posts comprising the steps of:
interconnecting national posts;
providing end-to-end visibility and tracking; and
facilitating payment between national posts.

2. The method of claim 1 further comprising the step of providing standardized interface specifications.

3. The method of claim 2 wherein said standardized interface specifications include a uniform tracking scheme.

4. The method of claim 1 further comprising the step of managing and expediting customs clearance.

5. The method of claim 1 wherein the step of providing end-to-end visibility and tracking includes transferring tracking information between initiating and destination national posts.

6. The method of claim 1 wherein the step of providing end-to-end visibility and tracking includes providing complete tracking information directly to customers and shippers through one access point.

7. The method of claim 1 wherein the step of facilitating payment between national posts includes apportioning and distributing payment for shipping costs between participating national posts.

8. The method of claim 1 further comprising the step of remitting payment for goods to merchandisers.

9. The method of claim 1 further comprising the step of digitally archiving shipped documents.

10. A computer-based system for interconnecting national posts to facilitate international shipment comprising:
a processor and
computer-readable medium encoding instructions for automated coordination of national posts, comprising modules encoding interrelated and interdependent processes, including
a plurality of post modules;
a tracking module; and
a payment module.

11. The computer-based system of claim 10 further comprising a memory device for storing shipment and tracking details.

12. The computer-based system of claim 11 wherein said memory device stores archived electronic documents.

13. The computer-based system of claim 10 wherein the post modules include processes for managing and expediting customs clearance.

14. The computer-based system of claim 10 wherein the tracking module interconnects the tracking systems of the post modules to provide end-to-end visibility and monitoring.

15. The computer-based system of claim 10 wherein the tracking module provides tracking information directly to customers and shippers.

16. The computer-based system of claim 10 wherein the payment module facilitates distribution of the shipping payment between the participating national posts.

17. The computer-based system of claim 10 wherein the payment module apportions the shipping payment between the participating national posts.

18. The computer-based system of claim 10 wherein the payment module allows a national post to act as a third-party-payor for remitting payment for goods to domestic merchandisers.
